(19) United States
(12) Patent Application Publication
(10) Pub. No.: US 2021/0247727 A1
(43) Pub. Date: Aug. 12, 2021

(54) A SYSTEM AND METHOD FOR PROVIDING POWER TO AUTHENTICATED DEVICES CONNECTED TO A RENEWABLE ENERGY SOURCE POWER UNIT

(71) Applicant: NOVA LUMOS LTD., Netanya (IL)

(72) Inventors: Nir NITZANI, Kfar Sava (IL); David VORTMAN, Tzur Moshe (IL); Nir MAROM, Tzur Moshe (IL); Rafael BONEH, Tel Aviv (IL)

(21) Appl. No.: 17/049,764

(22) PCT Filed: Apr. 4, 2019
(86) PCT No.: PCT/IL2019/050389

§ 371 Date: Oct. 22, 2020

Related U.S. Application Data
(60) Provisional application No. 62/661,027, filed on Apr. 22, 2018.
(60) Provisional application No. 62/661,028, filed on Apr. 22, 2018.

(51) Int. Cl. G05B 15/02; G06Q 50/06; G07F 15/00; G05F 1/66; G06F 21/30; H02S 10/00; H02J 1/14

(52) U.S. Cl. CPC G05B 15/02; G06Q 50/06; G07F 15/008; H02J 1/14; G06F 21/305; H02S 10/00; G05F 1/66

(57) ABSTRACT

An off-grid renewable energy harvesting device is disclosed, which provides electric power for purchase for general devices and for authenticated devices. In some embodiments only authenticated devices may be provided with electricity for purchase. In certain embodiments the authenticated devices may be provided electric power at a rate different than general devices. In some embodiments, secondary services may be provided by the authenticated devices. Secondary services may be providing communication, providing internet and internet-related services, video-on-demand services, digital video broadcasting, and the like.

### CROSS-REFERENCE TO RELATED APPLICATIONS

This application claims benefit from U.S. Provisional Patent Application No. 62/661,027 having a filing date of Apr. 22, 2018, and of U.S. Provisional Patent Application No. 62/661,028, having a filing date of Apr. 22, 2018. This application is also a continuation in part of U.S. Non-Provisional patent application Ser. No. 16/014,263 filed Jun. 21, 2018, which is itself a continuation of U.S. Non-Provisional patent application Ser. No. 14/593,298 to Marom et al. having a priority date of Jul. 12, 2012, now granted as U.S. Pat. No. 10,031,542, all contents of which are incorporated by reference herein.

### TECHNICAL FIELD

The disclosure generally relates to off-grid electrical harvesting stations, and particularly to providing power to certain devices using the same

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

Off-grid renewable energy sources, such as battery packs harvesting energy from solar panels, are beneficial in areas of the world where infrastructure is lacking. Whether this is due to lack of investment in infrastructure, or due to natural disaster, such energy sources can supply people with on-demand power, and are relatively quick and easy to deploy. Improving these systems, and increasing their value and offering, would therefore be a lucrative venture for those deploying such units.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a system for providing on-demand renewable energy, comprising: a power unit for converting environmental energy into electrical power, wherein the electrical power is drawn from an energy store of the power unit; a network interface controller (NIC), for connecting the system to a wireless network; an authentication unit, for determining if the system is providing the electrical power to an authorized device; and a regulator for controlling an amount of the electrical power drawn from the power unit based on an authorization rule, wherein the authorization rule is checked in response to an attempt to draw the electrical power from the power unit, the authorization rule being based at least on the authorized device; wherein the system is off-grid and initially installed at the authorized location.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a solar powered power station (SPPS) for providing secondary services, implemented in accordance with an embodiment.

FIG. 2 is a schematic illustration of an SPPS configured to provide electricity and secondary services, implemented in accordance with an embodiment.

FIG. 3 is a flowchart of a computerized method for providing power to an authenticated appliance from an SPPS, implemented in accordance with an embodiment.

FIG. 4 is a flowchart of a computerized method for providing secondary services from an SPPS, implemented in accordance with an embodiment.

FIG. 5 is a schematic illustration of an SPPS control server implemented according to an embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

An off-grid renewable energy harvesting device is disclosed, which provides electric power for purchase for general devices and for authenticated devices. In some embodiments only authenticated devices may be provided with electricity for purchase. In certain embodiments the authenticated devices may be provided electric power at a rate different than general devices. In some embodiments, secondary services may be provided by the authenticated devices. Secondary services may be providing communication, providing internet and internet-related services, video-on-demand services, digital video broadcasting, and the like.

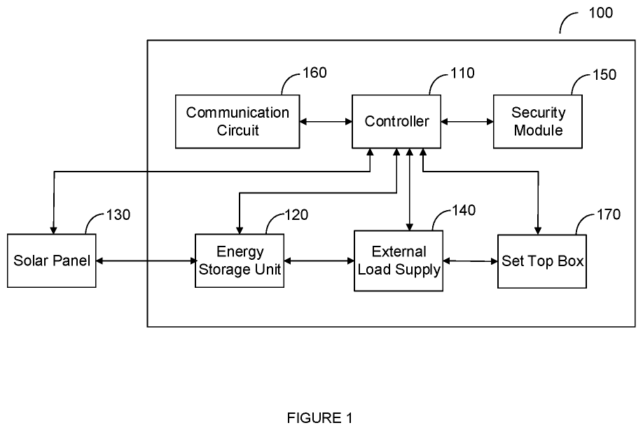

FIG. 1 is a schematic illustration of a solar powered power station (SPPS) for providing secondary services, implemented in accordance with an embodiment. An SPPS 100 includes a controller 110, for controlling the various elements of the SPPS 100. The controller 110 may include at least one processing element (not shown), for example, a central processing unit (CPU). In an embodiment, the processing element may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing element may be coupled, for example via a bus, to a memory (not shown). The memory may include a memory portion that contains instructions that when executed by the processing element performs the method described in more detail herein. The memory may be further used as a working scratch pad for the processing element, a temporary storage, and others, as the case may be. The memory may be a volatile memory such as, but not limited to random access memory (RAM), or non-volatile memory (NVM), such as, but not limited to, Flash memory. The processing element and/or the memory may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein. The controller 110 is communicatively coupled with an energy storage unit (ESU) 120, an external load supply 140, a security module 150, a communication circuit 160, a set top box (STB) 170, and a solar panel 130. The solar panel 130 is further connected to the ESU 120. It is readily understood that in other embodiments, other renewable energy sources may be used, without departing from the scope of this disclosure. The ESU 120 may be, for example, a lithium ion rechargeable battery. The external load supply 140 is operable for connecting to external electric loads. The external load supply may include, in some embodiments, a power regulator for supplying electrical power to external loads. An external electric load may be any device which requires electricity to run, such as, but in no way limited to, device chargers (such as phone charger, tablet charger, etc.), electric appliances (such as televisions, ovens, etc.), medical equipment, lighting devices, and the like. In an embodiment, the external load supply have an output for connecting to standard 5V (such as USB), 12V, 110V (for US appliances), and 220V (for EU appliances). A security module 150 is coupled with the controller to determine if the ESU should supply power, for example to the external load supply 140 from the ESU 120. The security module 150 may include authorization rules, or may receive an indication of supply from a SPPS control server (discussed in more detail below). For example, a user may authorize a payment to the SPPS control server. This can be done, for example by sending a textual message (for example over SMS protocol) which is predefined to authorize a sum, or a user defined sum of money, which corresponds to an amount of power supplied by the SPPS 100. The SPPS control server may then send an instruction to an SPPS associated with the user to supply an amount of power based on the authorized sum. The security module 150 configures the SPPS 100 to only supply power when an SPPS control server authorizes (or preauthorizes) to do so. In some embodiments, the security module 150 may further include an authentication component. For example, certain appliances may be fitted with an authentication component, used to identify the device. The SPPS 100 may be authorized to provide electricity to certain devices, which for example, a provider may wish to promote. By way of a non-limiting example, a provider may wish to allow use of a certain model and make of television, which is connected to the external load supply 140. As another example, the provider may wish to provide electricity from the SPPS 100 at a different price tier for an authenticated device (which is purchased through the provider). The SPPS 100 may communicate with the SPPS control server, with other SPPS units or any other device, through a communication circuit 160. The communication circuit 160 may be configured to connect the SPPS 100 to a network. In an embodiment, the network may be configured to provide connectivity of various sorts, as may be necessary, including but not limited to, wireless connectivity, including, for example, local area network (LAN), wide area network (WAN), metro area network (MAN), worldwide web (WWW), Internet, and any combination thereof, as well as cellular connectivity. In some embodiments, the STB 170 may provide secondary services, such as information services, entertainment services, or both. For the purpose of this disclosure, the primary service of the SPPS is providing electricity, and secondary services may be to provide entertainment and information services, for example. Each service provided through the STB 170 may be uni- or bi-directional. For example, a television broadcast is a unidirectional entertainment service, whereas providing an internet connection is a bi-directional information service, as information flows both ways. In some embodiments, the STB 170 may include, or be otherwise coupled with, an authentication device, for example to accept a SIM card, through which the device may be authorized. This may allow the STB 170 to supply the secondary services through multiple providers. For example a first provider may provide television broadcasts, or internet based broadcasts, while a second provider may provide general internet based services. In some embodiments, the SPPS may include a positioning system (not shown), such as a GPS receiver, which can be used by the SPPS or by an SPPS control server (discussed in more detail below) to determine a location of the SPPS. In such embodiments, power may further be supplied based on the determined location of the SPPS, i.e. power is supplied only if the SPPS is in an authorized location. The authorized location may be predetermined.

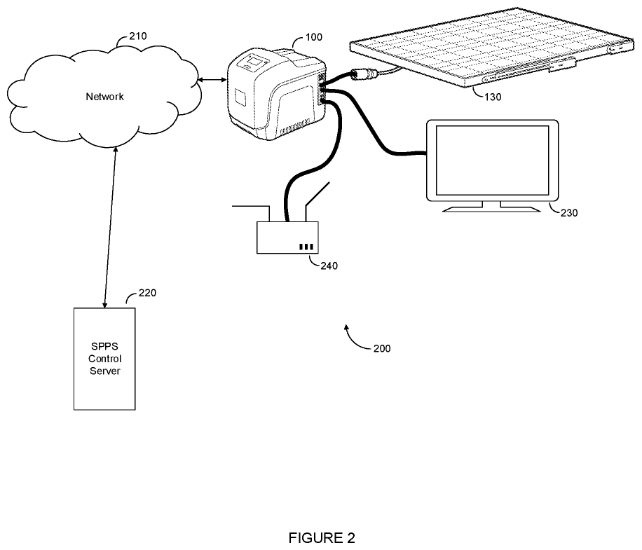

FIG. 2 is a schematic illustration 200 of an SPPS configured to provide electricity and secondary services, implemented in accordance with an embodiment. An SPPS 100 is communicatively coupled with a network 210, and via the network to an SPPS control server 220. The SPPS control server 220 is configured to send instructions and/or rules to the SPPS 100, through which the SPPS 100 may determine whether to supply power through an external load supply. The SPPS 100 is further connected to a renewable energy source; in this embodiment the energy source is a solar panel 130. The renewable energy source generates energy which is stored in an ESU of the SPPS 100 (such as shown in FIG. 1). The SPPS 100 may be connected to unauthenticated appliances, or authenticated appliances, such as television 230. An authenticated appliance may receive both a data link and a power link from the SPPS 100. The data link may be used to authenticate the appliance. Authentication can be performed, for example by providing a code, key, or the like from the appliance to the SPPS 100, which may then perform authentication with the SPPS control server 220. In some embodiments, authentication can be performed locally between the SPPS 100 and the authenticated appliance. The SPPS 100 may be configured, for example by the SPPS control server 220, to supply power to an authenticated appliance at a different monetary rate (for example, lower) than to an unauthenticated appliance. It is therefore beneficial to be able to distinguish between authenticated and unauthenticated devices. In some embodiments, authenticated devices may be further divisible into tiers, or groups, such that each tier is supplied power at a different rate. In this exemplary embodiment, the SPPS 100 is further connected to a router 240. In some embodiments, the router 240 may be a modem router, which is equipped to receive a line for communication transmissions. In some embodiments, the modem router may be a cellular modem. In other embodiments, a router may be integrated into the SPPS 100, as shown for example in FIG. 1. An integrated router may utilize the communication circuit of the SPPS 100 (of FIG. 1) to provide connectivity for other devices, for example by serving as a hotspot. Powering information appliances enables the SPPS 100 to supply both power (through the ELS 140) and (secondary) information and/or entertainment services. Information services may be an internet connection, a video-on-demand (VOD) service, internet television, and the like. Other over-the-top (OTT) services may be provided by the SPPS 100 as well, such as VoIP calling, messaging, and the like.

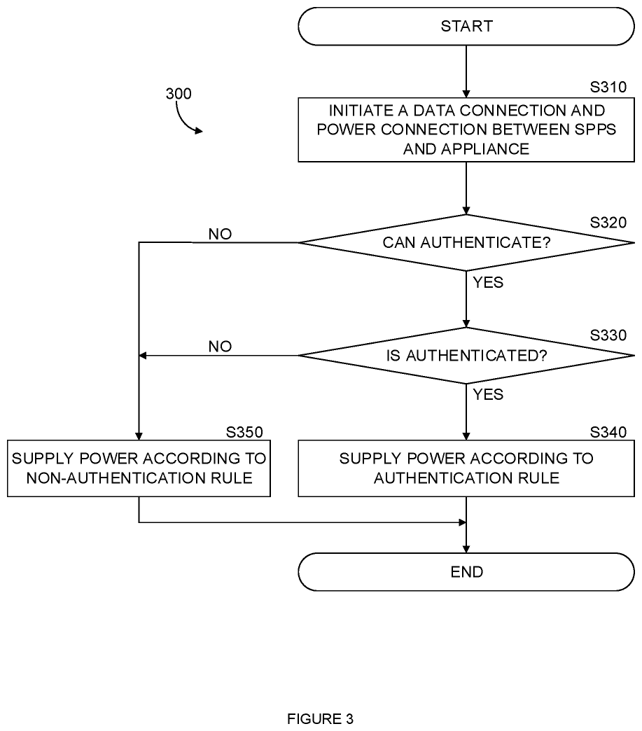

FIG. 3 is flowchart 300 of a computerized method for providing power to an authenticated appliance from an SPPS, implemented in accordance with an embodiment.

At S310 a power connection and a data connection are initiated between an appliance and an SPPS. In certain embodiments, the data connection and power connection may be supplied over a single wire, such as for example through a USB (Universal Serial Bus) type connection. The data connection and/or power connection may be wired or wireless.

At S320 check is performed to determine if authentication information may be received from the appliance. If ‘yes’ execution continues at S330 otherwise execution continues at S350.

At S330 a check is performed to determine if the appliance is authenticated. If ‘yes’ authentication continues at S340, otherwise execution continues at S350. In an exemplary embodiment, an appliance may include a key, code or other authenticating element stored in a memory therein. The appliance may send the authenticating element (a key, for the purpose of this example), to the SPPS. The SPPS may then perform an authentication of the appliance, based on the key. In certain embodiments, the SPPS may send the key to the SPPS control server, to determine if the appliance is authenticated. The SPPS control server may perform the determination, and send a reply to the SPPS. In some embodiments, the SPPS may supply a limited amount of power (trickle power) to the appliance to supply power to any elements therein required to perform the authentication of the appliance. Trickle power for the purpose of this disclosure is power supplied which is sufficient to operate elements which are required for authentication, but not enough power that can power an appliance for its intended use.

At S340 power is supplied according to a rule pertaining to authenticated appliances. The rules may be received for example from the SPPS control server. A rule may include an amount of power to be supplied to the device, for how long to supply the power, at what monetary rate to charge the use of the appliance (e.g. kilo-watt per hour per dollar), etc.

At S350 power is supplied according to a rule which pertains to unauthenticated appliances. By tiering appliances, manufacturers can incentivize consumers to purchase certain devices over others, which may lead to an increased revenue.

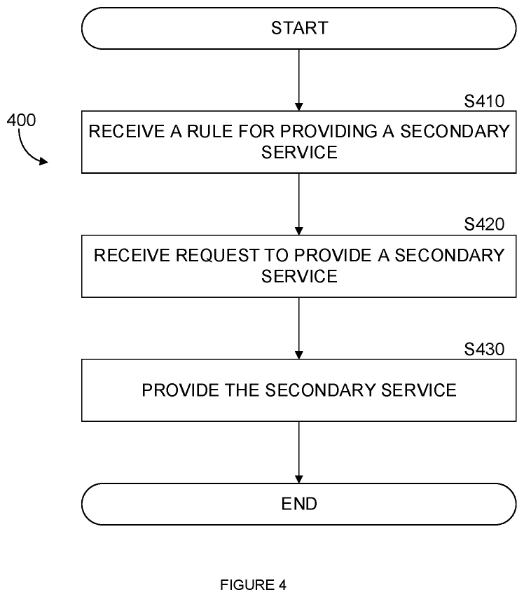

FIG. 4 is a flowchart 400 of a computerized method for providing secondary services from an SPPS, implemented in accordance with an embodiment.

At S410 a rule is received by an SPPS from an SPPS control server over a network, the rule pertaining to a secondary service. The rule may indicate, for example, if an SPPS should provide a secondary service, and under what conditions. The rule may also include one or more elements of the SPPS which should be powered on when providing the secondary service. For example, a rule may instruct the SPPS to power on a modem-router in response to a received instruction, or detected event.

At S420 a request is received to provide a secondary service. For example, a user device may send a request to power on a modem-router, to supply VOD content, and the like. The request may be sent to an SPPS control server in an embodiment, which may then indicate to the SPPS what action to perform, by sending an instruction to the SPPS over the network.

At S430 a secondary service is provided by the SPPS in response to determining that a condition of a rule pertaining to providing the secondary service has been satisfied, for example by powering on an element of the SPPS which provides the secondary service.

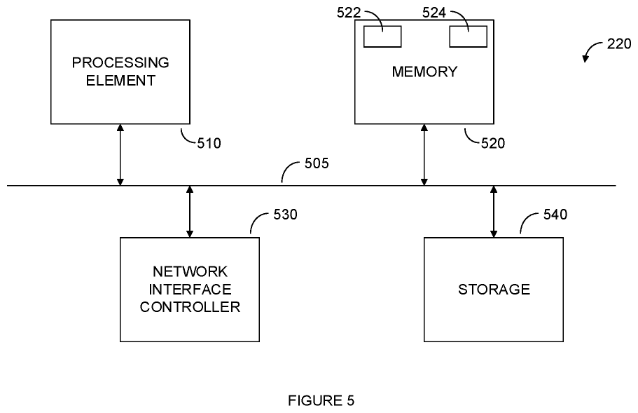

FIG. 5 is a schematic illustration of an SPPS control server 220 implemented according to an embodiment. The server 220 includes at least one processing element 510, for example, a central processing unit (CPU). In an embodiment, the processing element 510 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing element 510 is coupled via a bus 505 to a memory 520. The memory 520 may include a memory portion 522 that contains instructions that when executed by the processing element 510 performs the method described in more detail herein. The memory 520 may be further used as a working scratch pad for the processing element 510, a temporary storage, and others, as the case may be. The memory 520 may be a volatile memory such as, but not limited to random access memory (RAM), or non-volatile memory (NVM), such as, but not limited to, Flash memory. Memory 520 may further include memory portion 524 containing one or more rules for an SPPS to determine if the SPPS should provide power therefrom. In certain embodiments one or more rules may further determine at what monetary rate the power is provided (i.e. how much power does a unit of currency purchase). In some embodiments, the memory portion 524 may include authentication information, to determine if an appliance or device is authenticated. The processing element 510 may be coupled to a communication circuit 530 (or network interface controller—NIC). The communication circuit 530 provides the server 220 with network connectivity, for example to network 210 of FIG. 2. The processing element 510 may be further coupled with a storage 540. Storage 540 may be used for the purpose of holding a copy of the method executed in accordance with the disclosed technique. The processing element 510 and/or the memory 520 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A system for providing on-demand renewable energy, comprising:
a power unit comprising a solar panel and an energy storage unit, wherein the system is configured for supplying electrical power to a connected device;
an authentication unit, for determining an authorization status of said connected device; and
a regulator for controlling an amount of the electrical power drawn supplied to said connected device based on an authorization rule, wherein the authorization rule is checked in response to an attempt to draw the electrical power by said connected device from the power unit, and wherein the authorization rule is based on an identity of said authorized device;
wherein the system is off-grid.

2. The system of claim 1, wherein the device is any of: a television, a set top box, a router, a power charger, an electric appliance, a medical device, or a lighting device.

3. The system of claim 1, wherein said authorization rule configures the regulator to supply a first amount of electrical power to said connected device when it is authorized, and a second amount of electrical power to said connected device when it is unauthorized, wherein the first amount is larger than the second amount.

4. The system of claim 1, wherein said authorization rule configures the regulator to supply a first amount of electrical power over a first amount of time to said connected device when it is authorized, and a second amount of electrical power over a second amount of time to said connected device when it is unauthorized, wherein the first amount of time is longer than the second amount of time.

5. The system of claim 4, wherein the first amount of electrical power is equal to the second amount of electrical power.

6. The system of claim 1, wherein said authorization rule configures the regulator to stop said supplying of power to said connected device when it is unauthorized.

7. The system of claim 1, wherein said determining of said authorization status of said connected device is based on authentication information received from said connected device, wherein the authentication information is one of: a key, a passcode, a one-time passphrase, or any combination thereof.

8. The system of claim 7, wherein said system further comprises a network interface controller (NIC), for connecting the system to a wireless network, wherein the authentication information is transmitted wirelessly over the wireless network to a control server, and wherein the control server determines if the device is authenticated based on the authentication information.

9. The system of claim 7, wherein the regulator is configured to supply a first amount of electrical power to the device before said determining is, and a second amount of electrical power after said determining.

10. The system of claim 1, wherein the authorization rule is checked: periodically, once, or in response to each attempt to draw the electrical power from the power unit.
